(19) United States
(12) Patent Application Publication
(10) Pub. No.: US 2020/0398215 A1
(43) Pub. Date: Dec. 24, 2020

(54) WATER TREATMENT TANK AND DESULFURIZATION DEVICE

(71) Applicant: Mitsubishi Hitachi Power Systems, Ltd., Kanagawa (JP)

(72) Inventors: Masamichi IINO, Tokyo (JP); Takashi KAWANO, Tokyo (JP); Hiroshi KAWANE, Tokyo (JP); Hideaki SAKURAI, Tokyo (JP); Naoyuki KAMIYAMA, Tokyo (JP); Ryozo SASAKI, Yokohama-shi (JP); Tetsu USHIKU, Yokohama-shi (JP)

(21) Appl. No.: 16/971,600

(22) PCT Filed: Feb. 22, 2019
(86) PCT No.: PCT/JP2019/006809

§ 371 Date: Aug. 20, 2020

(30) Foreign Application Priority Data
Feb. 23, 2018 (JP) 2018-030609

(51) Int. Cl. B01D 53/14; C02F 1/74; B01D 53/18; B01F 3/04

(52) U.S. Cl. CPC B01D 53/1425; C02F 1/74; B01D 53/1481; C02F 2101/101; B01D 53/185; B01F 3/04248; B01D 53/1493

(57) ABSTRACT

A water treatment tank includes: a tank body including a bottom surface extending in a horizontal direction; an overflow wall partitioning the inside of the tank body into an upstream tank into which treatment water having absorbed sulfur from an exhaust gas is introduced and a downstream tank into which the treatment water overflowing from the upstream tank is introduced to flow therein; and an inclined part that is provided between the bottom surface of the tank body and the overflow wall in the downstream tank and is inclined downward as it goes from the overflow wall toward a downstream side inside the downstream tank to be connected to the bottom surface of the tank body.

### TECHNICAL FIELD

The present invention relates to a water treatment tank and a desulfurization device. Priority is claimed on Japanese Patent Application No. 2018-030609, filed Feb. 23, 2018, the content of which is incorporated herein by reference.

### BACKGROUND ART

Generally, since it is necessary to absorb and remove sulfur dioxide (SO2) from an exhaust gas discharged from coal-fired boilers and the like, a desulfurization device is provided in a power plant and the like. The desulfurization device absorbs SO2 in the exhaust gas into seawater in a desulfurization absorption tower and performs oxidization treatment by allowing used seawater to contact a large amount of air in an oxidization tank.

As the desulfurization device, there is known one in which a weir (overflow wall) is provided in a water channel to supply more air to the used seawater supplied to the oxidization tank and the water passing over the weir is dropped into the tank like a waterfall. Since the seawater is dropped into the oxidization tank like that, fine air bubbles are supplied to the seawater to promote oxidization (for example, see Patent Literature 1).

### CITATION LIST

### Patent Document

Patent Document 1: Japanese Unexamined Patent Application, First Publication No. 2012-115764

### SUMMARY OF INVENTION

### Technical Problem

Incidentally, when the weir is installed in the water channel so that the seawater is dropped into the tank like a waterfall to supply air, it is necessary to secure a sufficient head. However, a method of further strengthening oxidization without increasing the head is required. Particularly, in order to progress the oxidization, air bubbles need to be retained in the seawater for a longer time.

An object of the present invention is to provide a water treatment tank and a desulfurization device capable of retaining air bubbles generated by overflowing treatment water in the treatment water for a longer time.

### Solution to Problem

According to a first aspect of the present invention, a water treatment tank includes: a tank body that includes a bottom surface extending in a horizontal direction; an overflow wall installed in the tank body to partition an inside space of the tank body into an upstream tank into which treatment water having absorbed sulfur from an exhaust gas is introduced and a downstream tank into which the treatment water overflowing from the upstream tank is introduced to flow therein; and an inclined part which is installed between the bottom surface and the overflow wall in the downstream tank, wherein the inclined part is inclined downward from the overflow wall toward a downstream side of the downstream tank and of which a downstream end is connected to the bottom surface.

According to such a configuration, since the treatment water flows over the overflow wall and drops into the downstream tank, and then collides with the water surface so that fine air bubbles are generated in the treatment water. The treatment water flowed into the downstream tank collides with the inclined part along with the generated air bubbles and flows to the downstream side along the bottom surface due to the inclination of the inclined surface. Accordingly, air bubbles inside the downstream tank can be retained in the treatment water for a longer time.

The water treatment tank may further include a perforated plate having a plate shape and of which a main surface is disposed along the bottom surface, wherein the perforated plate is provided with a plurality of through-holes.

According to such a configuration, the perforated plate can suppress air bubbles from rising and retain air bubbles in the treatment water for a longer time.

The water treatment tank may further include a bubble generator that is installed under the perforated plate and that is configured to supply bubbles to the downstream tank.

According to such a configuration, the perforated plate can suppress not only air bubbles generated by the overflow wall but also air bubbles generated by the bubble generator from rising and can retain air bubbles in the treatment water for a longer time.

According to a second aspect of the present invention, a water treatment tank includes: a tank body that includes a bottom surface extending in a horizontal direction; an overflow wall installed in the tank body to partition an inside space of the tank body into an upstream tank into which treatment water is introduced from an external water region and a downstream tank into which the treatment water overflowing from the upstream tank is introduced to flow therein; and an inclined part is installed between the bottom surface and the overflow wall in the downstream tank, wherein the inclined part is inclined downward from the overflow wall toward a downstream side of the downstream tank and of which a downstream end is connected to the bottom surface.

The water treatment tank may further include a bypass flow passage through which the upstream tank is connected with the downstream tank wherein the treatment water supplied from the upstream tank through the bypass flow passage flows along a bottom surface of the downstream tank.

According to such a configuration, the treatment water in the vicinity of the inclined part is pushed toward the downstream side by the bypass steam flowing through the bypass flow passage and a force pushing air bubbles toward the downstream side can be made strong by this stream. Accordingly, air bubbles can be retained in the treatment water for a longer time. Further, the bypass stream can lower the water level in a water falling area.

The water treatment tank may further include a partition plate that is disposed so that at least a part of which interferes with the treatment water inside the downstream tank, wherein a flow of the treatment water reversely flowing toward an upstream side of the partition plate is reduced.

According to such a configuration, the partition plate can reduce the flow of the treatment water reversely flowing toward the water falling area and the bypass stream can maintain the lowered water level.

The water treatment tank may further include a division plate that is disposed between an upper end of the overflow wall and a water surface of treatment water passing over the overflow wall wherein the treatment water is divided by the division plate into first falling water falling to an upstream side and a second falling water falling to a downstream side.

According to such a configuration, it is possible to increase the number of the collision points with the water surface after the water falls by dividing the falling water, to increase the amount of generated air bubbles, and to increase the amount of air taken into the treatment water.

The water treatment tank may further include an air supply device that is configured to supply ambient air into treatment water by using a pressure of a falling water in the vicinity of a water surface or treatment water passing over the overflow wall.

According to such a configuration, the amount of air bubbles supplied to the treatment water can be increased.

According to a third aspect of the present invention, a desulfurization device includes: any one of the above-described water treatment tanks; desulfurization absorption tower which is configured to remove SO2 in an exhaust gas by absorbing SO2 into seawater; and a drainage line which is configured to introduce used seawater discharged from the desulfurization absorption tower to the water treatment tank.

According to such a configuration, oxygen can be efficiently supplied to the used seawater. Accordingly, the water treatment tank can have a compact size.

### Advantageous Effects of Invention

According to the present invention, the treatment water flows over the overflow wall and drops into the downstream tank, and then collides with the water surface so that fine air bubbles are generated in the treatment water. The treatment water flowed into the downstream tank collides with the inclined part along with the generated air bubbles and flows to the downstream side along the bottom surface due to the inclination of the inclined surface. Accordingly, air bubbles inside the downstream tank can be retained in the treatment water for a longer time.

### BRIEF DESCRIPTION OF DRAWINGS

FIG. 1 is a schematic configuration diagram of a desulfurization device of a first embodiment of the present invention.

FIG. 2 is a cross-sectional view of a seawater intake tank of the first embodiment of the present invention.

FIG. 3 is a cross-sectional view of an oxidization tank of a second embodiment of the present invention.

FIG. 4 is a cross-sectional view of a seawater intake tank of a third embodiment of the present invention.

FIG. 5 is a cross-sectional view of a seawater intake tank of a modified example of the third embodiment of the present invention.

FIG. 6 is a cross-sectional view of a seawater intake tank of a fourth embodiment of the present invention.

FIG. 7 is a cross-sectional view of a pipe provided in a seawater intake tank of a fifth embodiment of the present invention.

FIG. 8 is a cross-sectional view of a seawater intake tank of a modified example of the fifth embodiment of the present invention.

### DESCRIPTION OF EMBODIMENTS

### First Embodiment

Hereinafter, a desulfurization device of a first embodiment of the present invention will be described in detail with reference to the drawings.

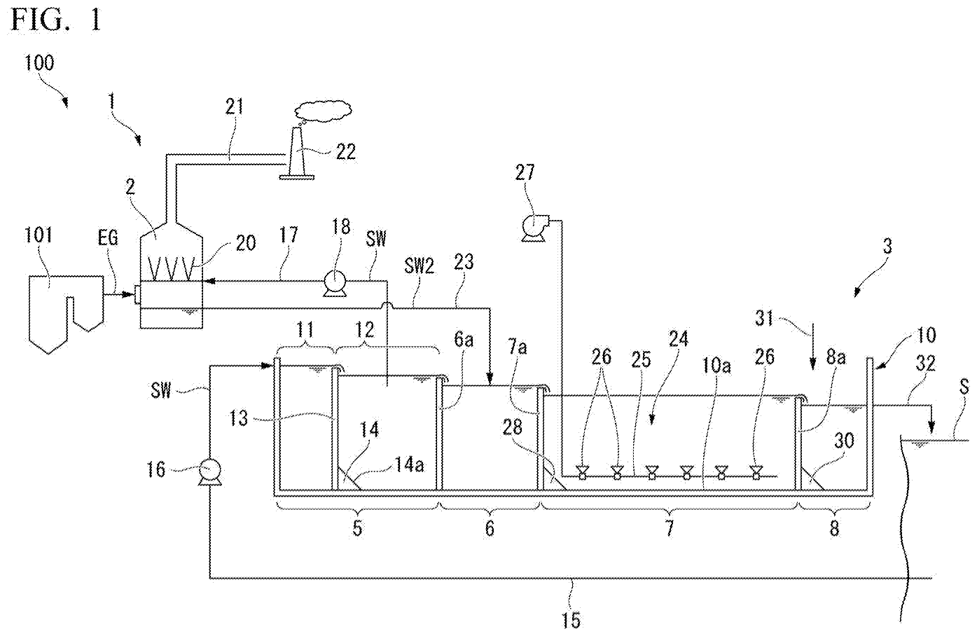

As shown in FIG. 1, a plant 100 having a desulfurization device 1 of the embodiment includes a coal-fired or heavy oil-fired boiler 101 and the desulfurization device 1.

The desulfurization device 1 includes a desulfurization absorption tower 2 which removes SO2 (sulfur content) in an exhaust gas EG discharged from the boiler 101 by absorbing it into seawater SW (treatment water) and a water treatment tank 3 which is configured as an oxidization tank 7 or the like for oxidizing used seawater SW2 discharged from the desulfurization absorption tower 2.

The boiler 101 includes a steam turbine which is driven by steam generated by the boiler 101, a generator which generates power by driving the steam turbine, and the like.

The water treatment tank 3 includes a tank body 10 which has a bottom surface 10a extending in a horizontal direction and a plurality of overflow walls 13, 6a, 7a, and 8a which partition the tank body 10. The water treatment tank 3 is partitioned by the overflow walls into a seawater intake tank 5 into which the seawater SW is introduced, a mixing tank 6 into which the seawater SW overflowing from the seawater intake tank 5 and the used seawater SW2 having absorbed SO2 in the desulfurization absorption tower 2 are introduced, the oxidization tank 7 (aeration tank) which oxidizes the seawater SW by being in contact with a large amount of air, and a finishing tank 8 (dilution tank) which is disposed at the rear stage of the oxidization tank 7.

Additionally, in FIG. 1, the height of the bottom surface 10a of the water treatment tank 3 is constant in the entire length, but the height of the bottom surface 10a of the water treatment tank 3 is lowered toward the downstream tank.

These tanks are sequentially disposed from the upstream side to be adjacent to each other in order of the seawater intake tank 5, the mixing tank 6, the oxidization tank 7, and the finishing tank 8. These tanks are configured such that the seawater SW overflowing from the more upstream tank is taken in by adjacent downstream tanks.

The seawater intake tank 5 includes a tank body 10, the seawater intake tank overflow wall 13 which partitions the inside of the seawater intake tank 5 into a seawater intake upstream tank 11 and a seawater intake downstream tank 12, a mixing tank overflow wall 6a which partitions the inside of the seawater intake tank 5 into the seawater intake downstream tank 12 and the mixing tank 6, and a seawater intake tank inclined part 14 which is provided between the bottom surface 10a and the seawater intake tank overflow wall 13 in the seawater intake downstream tank 12.

The seawater SW is introduced from the sea which is an external water region into the seawater intake upstream tank 11 through a seawater introduction line 15. The seawater introduction line 15 is provided with a pump 16. The seawater SW overflowing from the seawater intake upstream tank 11 is introduced into the seawater intake downstream tank 12. The seawater SW passing over the seawater intake tank overflow wall 13 is changed into a waterfall.

The seawater intake downstream tank 12 is provided with a desulfurization seawater line 17 and a pump 18 that send a part of the seawater SW to the desulfurization absorption tower 2.

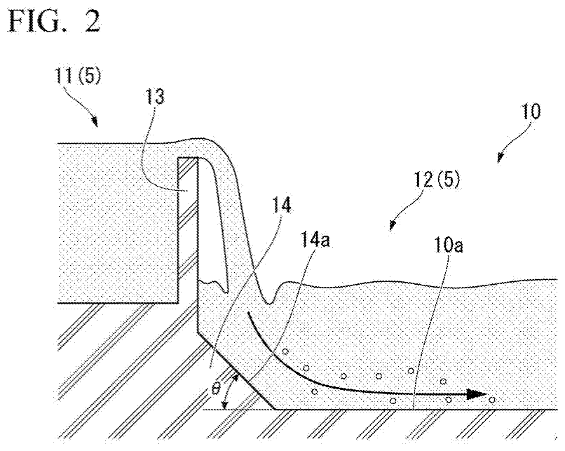

As shown in FIG. 2, the seawater intake tank inclined part 14 is inclined downward from the seawater intake tank overflow wall 13 toward the downstream side inside the seawater intake downstream tank 12 and is connected to the bottom surface 10a. The seawater intake tank inclined part 14 is provided at a position where the seawater SW overflowing from the seawater intake upstream tank 11 collides. The seawater intake tank inclined part 14 includes a planar inclined surface 14a. The bottom surface 10a and the inclined surface 14a intersect each other to form an obtuse angle. The seawater intake tank overflow wall 13 and the inclined surface 14a intersect each other to form an obtuse angle. An angle □ formed by the bottom surface 10a and the inclined surface 14a is, for example, preferably 25□ to 45□ and more preferably 28□ to 35□.

As shown in FIG. 1, a plurality of spray nozzles 20 are provided inside the desulfurization absorption tower 2 to bring the exhaust gas into gas-liquid contact with the seawater SW as an absorption liquid. An exhaust gas outlet 21 of the desulfurization absorption tower 2 is provided with a chimney 22 for discharging a desulfurized exhaust gas to the atmosphere. A drainage line 23 which sends the used seawater SW2 having absorbed SO2 discharged from the desulfurization absorption tower 2 to the mixing tank 6 is provided between the desulfurization absorption tower 2 and the mixing tank 6.

The mixing tank 6 includes the tank body 10, the mixing tank overflow wall 6a, and the oxidization tank overflow wall 7a which partitions the tank body 10 into the mixing tank 6 and the oxidization tank 7. The mixing tank 6 is configured to receive the seawater SW overflowing from the seawater intake tank 5 and to introduce the used seawater SW2 discharged from the desulfurization absorption tower 2 thereinto.

The oxidization tank 7 includes the tank body 10, the oxidization tank overflow wall 7a, the finishing tank overflow wall 8a which partitions the tank body 10 into the oxidization tank 7 and the finishing tank 8, and an oxidization tank inclined part 28 which is provided between the bottom surface 10a of the tank body 10 and the oxidization tank overflow wall 7a. The oxidization tank 7 is configured to receive the seawater SW containing the used seawater SW2 overflowing from the mixing tank 6 so that the seawater SW flows from one end to the other end.

The oxidization tank 7 includes a bubble generator 24 which supplies bubbles (air) to the seawater SW in the oxidization tank 7. The bubble generator 24 includes an air line 25 which is disposed in a bottom portion of the oxidization tank 7 and a plurality of bubble blowing nozzles 26 which are provided in the air line 25 and blow out bubbles in multiple stages in the flow direction of the seawater SW. The air line 25 is provided with an oxidization air compressor 27 which sends air in atmosphere to the bubble blowing nozzle 26.

The configuration of the oxidization tank inclined part 28 is the same as that of the seawater intake tank inclined part 14. That is, the oxidization tank inclined part 28 is provided at a position where the seawater SW overflowing from the mixing tank 6 collides. The oxidization tank inclined pan 28 includes a planar inclined surface. The bottom surface 10a and the inclined surface intersect each other to form an obtuse angle. The oxidization tank overflow wall 7a and the inclined surface intersect each other to form an obtuse angle. An angle □ formed between the bottom surface 10a and the inclined surface is, for example, preferably 25□ to 45□ and more preferably 28□ to 35□.

The finishing tank 8 includes the tank body 10, the finishing tank overflow wall 8a, and a finishing tank inclined part 30 which is provided between the bottom surface 10a and the finishing tank overflow wall 8a. The finishing tank 8 is configured to receive the used seawater SW2 overflowing from the oxidization tank 7, and the seawater SW for diluting the used seawater SW2 is poured into the finishing tank 8 through the dilution seawater line 31. The downstream end portion of the finishing tank 8 is provided with a discharge port 32 for discharging the seawater SW.

The configuration of the finishing tank inclined part 30 is the same as those of the seawater intake tank inclined part 14 and the oxidization tank inclined pan 28. That is, the finishing tank inclined part 30 is provided at a position where the seawater SW overflowing from the oxidization tank 7 collides. The finishing tank inclined part 30 includes a planar inclined surface. The bottom surface 10a and the inclined surface intersect each other to form an obtuse angle. The finishing tank overflow wall 8a and the inclined surface intersect each other to form an obtuse angle. An angle □ formed between the bottom surface 10a and the inclined surface is, for example, preferably 25□ to 45□ and more preferably 28□ to 35□.

Next, the operation of the desulfurization device 1 of the embodiment will be described.

In the boiler 101, the steam turbine is driven by using steam and power is generated by the generator. The exhaust gas EG generated front the boiler 101 is introduced into the desulfurization absorption tower 2 and the heated seawater SW is sprayed as the absorption liquid to the exhaust gas EG. Accordingly, SO2 in the exhaust gas EG is absorbed by the seawater SW and is changed into sulfites such as sulfurous acid (H2SO3), bisulfite ion (HSO3-), and sulfite ion (SO32-) in the seawater SW. The exhaust gas EG from which SO2 has been removed is released from the chimney 22 to the atmosphere. The used seawater SW2 having absorbed SO2 is discharged from the desulfurization absorption tower 2 and is introduced into the mixing tank 6 through the drainage line 23.

On the other hand, the seawater SW is introduced into the seawater intake tank 5 disposed at the most upstream side of the water treatment tank 3 through the seawater introduction line 15. The seawater SW is supplied to the desulfurization absorption tower 2 through the desulfurization seawater line 17.

In the mixing tank 6, the seawater SW overflowing from the seawater intake tank 5 and the used seawater SW2 discharged from the desulfurization absorption tower 2 are mixed and diluted.

The used seawater SW2 discharged from the desulfurization absorption tower 2 generally has low pH. Thus, the pH can be raised to a value (for example, pH6 or more) at which the oxidization reaction rapidly progresses through aeration by the dilution in the mixing tank 6.

Further, the used seawater SW2 discharged from the desulfurization absorption tower 2 generally has a high concentration of SO32-. Thus, the concentration of SO32—in the used seawater SW2 can be decreased to a value (for example, 1.2 mmol/liter or less) at which SO2 does not diffuse into the gas phase due to this dilution. The mixed used seawater SW2 is introduced into the oxidization tank 7 by overflowing from the mixing tank 6.

Next, bubbles (air) are blown into the seawater SW (used seawater SW2) flowing in the oxidization tank 7 from the bubble blowing nozzle 26 of the bubble generator 24 to perform an oxidization treatment (aeration treatment). As a result, SO32—in the used seawater SW2 is oxidized to SO42- to be chemically harmless. The seawater SW which is oxidized in the oxidization tank 7 overflows from the oxidization tank 7 to be introduced into the finishing tank 8.

Next, the seawater SW is put into the used seawater SW2 flowing in the finishing tank 8 through the dilution seawater line 31 to dilute the seawater SW. Accordingly, pH of the seawater SW can be improved. Finally, the seawater SW whose SO32—concentration has dropped below the emission standard is released from the discharge port 32.

In the seawater intake tank 5, air bubbles are generated when the seawater SW overflowing from the seawater intake tank overflow wall 13 collides with the water surface of the seawater intake downstream tank 12. The inflowing seawater SW collides with the seawater intake tank inclined part 14 along with the generated air bubbles and flows toward the downstream side along the bottom surface 10a due to the inclination of the inclined surface 14a. That is, after air bubbles collide with the bottom surface 10a, air bubbles do not rise right away, are retained on the bottom surface 10a, and flow to spread as a whole. Accordingly, the dissolved oxygen amount (X) of the seawater SW in the seawater intake downstream tank 12 is easily saturated.

In the oxidization tank 7, bubbles are generated when the seawater SW passing over the oxidization tank overflow wall 7a collides with the water surface of the oxidization tank 7. The inflowing seawater SW collides with the oxidization tank inclined part 28 along with the generated air bubbles and flows toward the downstream side along the bottom surface 10a due to the inclination of the inclined surface. Accordingly, the oxidization inside the oxidization tank 7 is promoted.

Also in the finishing tank 8, similarly to the oxidization tank 7, the seawater SW passing over the finishing tank overflow wall 8a collides with the water surface so that bubbles are generated. The inflowing seawater SW collides with the finishing tank inclined par 30 along with the generated air bubbles and flows toward the downstream side along the bottom surface 10a due to the inclination of the inclined surface. Accordingly, finish oxidization before discharge is promoted.

According to the above-described embodiment, the seawater SW flows over the overflow walls 13, 6a, 7a, and 8a and drops into each of the downstream tank like a waterfall, and then collides with the water surface, so that fine air bubbles are generated in the seawater. The seawater SW flowing into the downstream tank collides with the inclined parts 14, 28, and 30 along with the generated air bubbles and flows toward the downstream side along the bottom surface 10a due to the inclination of the inclined surface. Accordingly, air bubbles can be retained in the downstream tank for a longer time.

Further, since oxygen can be efficiently supplied to the seawater, the oxidization tank 7 can have a compact size.

Additionally, the seawater intake tank overflow wall 13, the oxidization tank overflow wall 7a, and the finishing tank overflow wall 8a are provided with the inclined parts 14, 28, and 30 in the above-described embodiment, but all overflow walls may not be provided with the inclined parts. If necessary, the overflow wall provided with the inclined part can be selected.

### Second Embodiment

Hereinafter, a desulfurization device of a second embodiment of the present invention will be described in detail with reference to the drawings. Additionally, in the embodiment, a difference from the first embodiment will be chiefly described and the description of the same parts will be omitted.

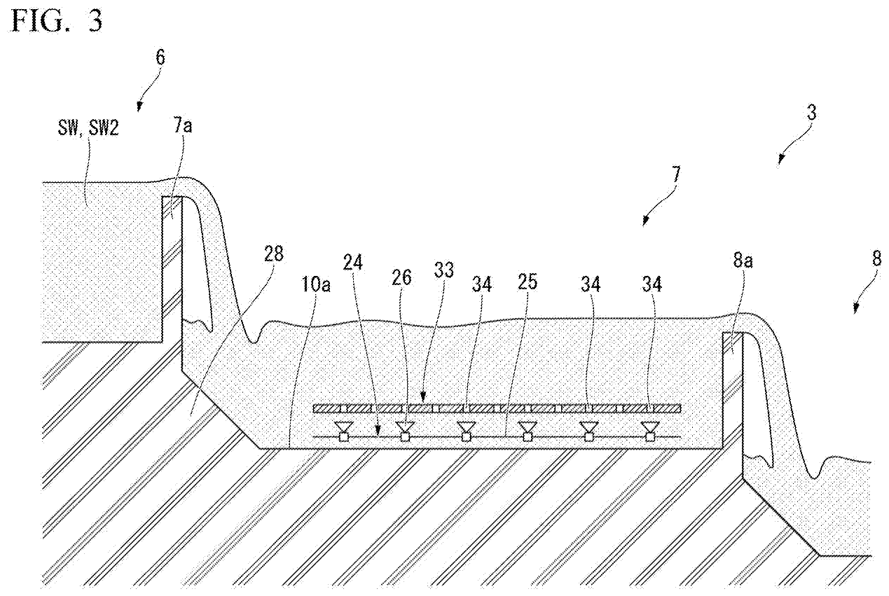

As shown in FIG. 3, the oxidization tank 7 of the embodiment includes a plate-shaped perforated plate 33 which is disposed in parallel to the bottom surface 10a. The shape of the perforated plate 33 corresponds to the shape of the bottom surface 10a (the oxidization tank 7) and a main surface is parallel to the bottom surface 10a. The perforated plate 33 is formed to cover the bottom surface 10a when viewed from above. The perforated plate 33 is disposed to cover the bubble blowing nozzle 26 of the bubble generator 24 when viewed from above. Additionally, the perforated plate 33 does not need to be parallel to the bottom surface 10a and may be inclined with respect to the bottom surface 10a when the perforated plate is disposed along the bottom surface 10a. Further, the perforated plate 33 does not need to over the entire surface of the bottom surface 10a (the bubble blowing nozzle 26) and the perforated plate 33 may be disposed only on the upstream side of the oxidization tank 7.

The upstream end portion of the perforated plate 33 is disposed at a position where the upstream end portion does not interfere with the oxidization tank inclined part 28.

A plurality of through-holes 34 are formed in the perforated plate 33. It is preferable that the through-holes 34 be evenly arranged. The perforated plate 33 can be formed of, for example, punching metal or wire mesh.

According to the above-described embodiment, air bubbles generated in the oxidization tank overflow wall 7a and air bubbles generated in the bubble generator 24 are suppressed from rising by the perforated plate 33 and hence air bubbles can be retained in the seawater SW for a longer time.

Additionally, the oxidization tank 7 is provided with the perforated plate 33 in the above-described embodiment, but the present invention is not limited thereto. For example, the perforated plate 33 may be provided in another tank provided with an inclined part to suppress air bubbles from rising.

### Third Embodiment

Hereinafter, a desulfurization device of a third embodiment of the present invention will be described in detail with reference to the drawings. Additionally, in the embodiment, a difference from the first embodiment will be chiefly described and the description of the same parts will be omitted.

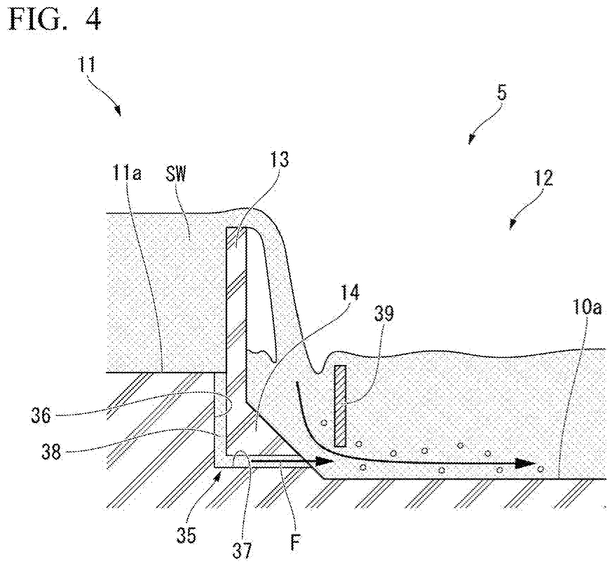

As shown in FIG. 4, the desulfurization device of the embodiment includes a bypass flow passage 35 which is formed in the seawater intake tank inclined part 14 and connects the seawater intake upstream tank 11 and the seawater intake tank inclined part 14 so that the seawater SW inside the seawater intake upstream tank 11 flows along the bottom surface 10a of the seawater intake downstream tank 12.

The bypass flow passage 35 includes a bypass flow passage inlet 36 which is formed in a bottom surface 11a of the seawater intake upstream tank 11, a bypass flow passage outlet 37 which is formed in the seawater intake tank inclined part 14, and a bypass flow passage body 38 which connects the bypass flow passage inlet 36 and the bypass flow passage outlet 37 to each other.

The bypass flow passage outlet 37 is formed at the lower portion of the seawater intake tank inclined part 14. A plurality of the bypass flow passages 35 are provided in the width direction of the seawater intake tank inclined pan 14 (a direction perpendicular to the paper surface of FIG. 4).

Further, the desulfurization device 1 of the embodiment includes a partition plate 39 of which a main surface is formed along the vertical direction and at least a pan is disposed to interfere with the seawater SW inside the seawater intake downstream tank 12.

The partition plate 39 is disposed so that the lower end of the partition plate 39 is higher than the bypass flow passage outlet 37 of the bypass flow passage 35. The partition plate 39 is disposed on the slightly downstream side of the seawater intake tank inclined part 14. The upper end of the partition plate 39 is formed to be lower than the water surface of the seawater SW.

Additionally, the partition plate 39 does not need to be formed along the vertical direction and may be formed so as to reduce the flow of the seawater SW reversely flowing toward the upstream side of the partition plate 39.

According to the above-described embodiment, the seawater SW in the vicinity of the seawater intake tank inclined part 14 is pushed toward the downstream side by a bypass stream F flowing through the bypass flow passage 35 and a force pushing air bubbles toward the downstream side can be made strong by this stream. Accordingly, air bubbles can be retained in the seawater SW for a longer time. Further, the bypass stream F can lower the water level in the water falling area.

Further, the partition plate 39 can reduce the flow of the seawater SW reversely flowing toward the water falling area and the bypass stream F can maintain the lowered water level. By lowering the water level in the water falling area, the height of the waterfall can be earned. Further, air bubbles can be easily drawn due to the drawing flow.

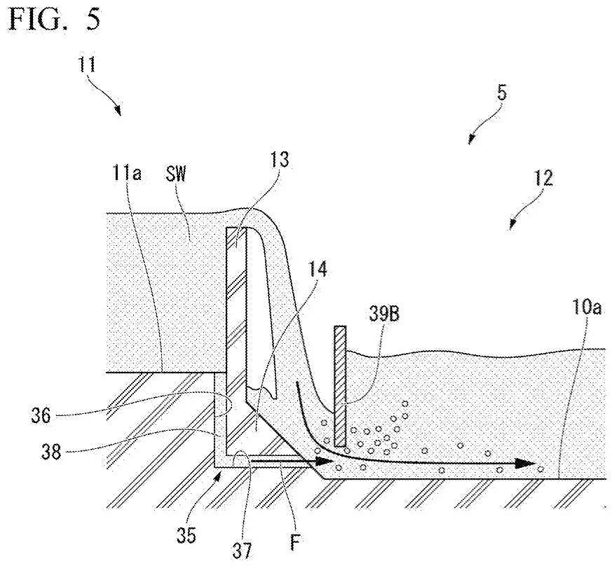

Additionally, the partition plate 39 of the above-described embodiment is formed so that the upper end of the partition plate 39 is lower than the water surface of the seawater SW, but the present invention is not limited thereto. For example, a, shown in FIG. 5, an upper end of a partition plate 398 may be formed to be higher than the water surface of the seawater SW. According to the partition plate 39B, it is possible to further reduce the flow of the seawater SW reversely flowing toward the upstream side.

Further, the bypass flow passage outlet 37 of the bypass flow passage 35 of the embodiment is formed in the seawater intake tank inclined pan 14, but the present invention is not limited thereto. For example, the bypass flow passage outlet 37 may be formed in the bottom surface 10a.

Further, the bypass flow passage 35 and the partition plate 39 of the embodiment may be provided not only before and after the seawater intake tank overflow wall 13 but also before and after the oxidization tank overflow wall 7a or the finishing tank overflow wall 8a.

### Fourth Embodiment

Hereinafter, a desulfurization device of a fourth embodiment of the present invention will be described in detail with reference to the drawings. Additionally, in the embodiment, a difference from the first embodiment will be chiefly described and the description of the same parts will be omitted.

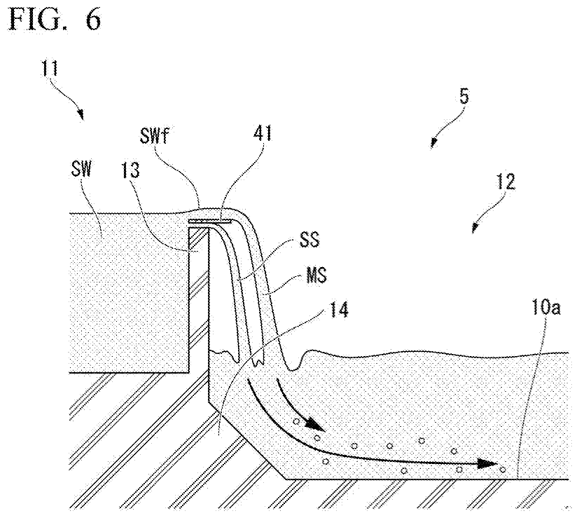

As shown in FIG. 6, the desulfurization device of the embodiment includes a division plate 41 which is disposed between the upper end of the seawater intake tank overflow wall 13 and a water surface SWf of the seawater SW passing over the seawater intake tank overflow wall 13.

The division plate 41 is disposed so that the seawater SW passing over the seawater intake tank overflow wall 13 is divided into a small flow rate of a sub-stream SS (first falling water) and a large flow rate of a main stream MS (second falling water). The division plate 41 of the embodiment is disposed so that the seawater SW flowing between the division plate 41 and the upper end of the seawater intake tank overflow wall 13 becomes the sub-stream SS and the seawater SW flowing above the division plate 41 becomes the main stream MS. Accordingly, the sub-stream SS falls to the upstream side and the main stream MS falls to the downstream side. For example, the flow rate of the main stream MS can be twice the flow rate of the sub-stream SS.

According to the above-described embodiment, it is possible to increase the number of the collision points with the water surface after the waterfalls by dividing the falling water, to increase the amount of generated air bubbles, and to increase the amount of air taken into the seawater SW.

Further, air bubbles generated in the sub-stream SS can be carried further by the flow of the main stream MS by making the flow rate of the main stream MS larger than the flow rate of the sub-stream SS.

Additionally, in the above-described embodiment, the falling water falling to the upstream side is the sub-stream SS and the falling water falling to the downstream side is the main stream MS. However, the present invention is not limited thereto. For example, the falling water falling to the upstream side may be the mainstream MS and the falling water falling to the downstream side may be the sub-stream SS. Further, the main stream MS and the sub-stream SS may have the same flow rate. Further, the plurality of division plates 41 may be disposed to divide the falling water into three or more.

Further, the division plate 41 is provided above the seawater intake tank overflow wall 13 in the above-described embodiment, but the division plate 41 may be provided above the oxidization tank overflow wall 7a or the finishing tank overflow wall 8a.

### Fifth Embodiment

Hereinafter, a desulfurization device of a fifth embodiment of the present invention will be described in detail with reference to the drawings. Additionally, in the embodiment, a difference from the first embodiment will be chiefly described and the description of the same parts will be omitted.

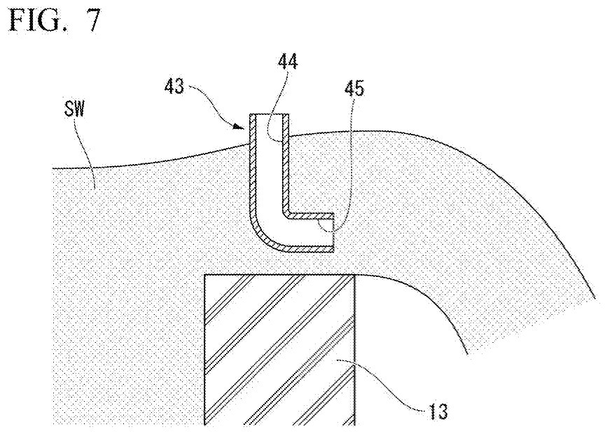

As shown in FIG. 7, the desulfurization device of the embodiment includes a pipe 43 (an air supply device) which supplies ambient air into the seawater SW by using the flow of the seawater SW passing over the seawater intake tank overflow wall 13. The pipe 43 is disposed inside the water stream immediately before the water falls.

The pipe 43 includes an air suction portion 44 which takes in air into the pipe 43 and an air ejection portion 45 which ejects air taken in from the air suction portion 44. In addition, air may be supplied by a compressor or the like.

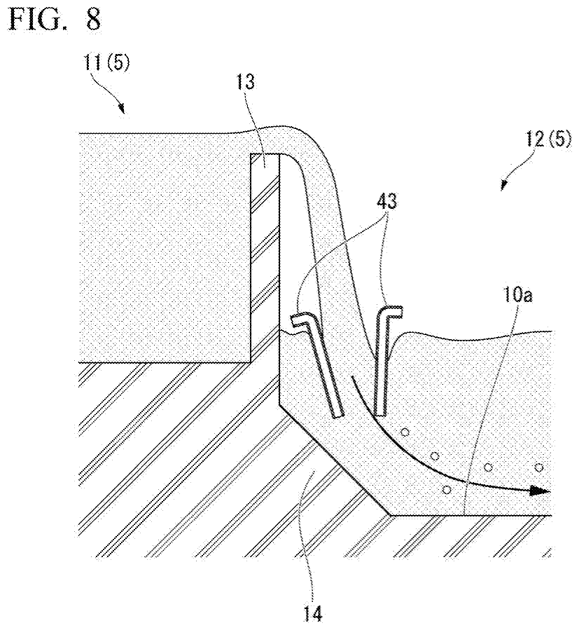

Further, the installation position of the pipe 43 is not limited to the above-described position. For example, as shown in FIG. 8, the pipe 43 may be disposed at a portion having a large velocity gradient immediately after the water falls.

When the pipe 43 is disposed at such a position to increase the amount of entrained air after the water falls, the air inclusion amount can be increased.

According to the above-described embodiment, air is mixed due to air ejected by an ejector effect and hence the dissolved oxygen amount of the seawater SW can be effectively improved. Particularly, it is possible to increase the air inclusion amount by increasing the amount of air in the water stream falling down.

Further, it is possible to supply air without providing a power source such as a blower by using the ejector effect.

Although the embodiment of the present invention has been described in detail with reference to the drawings, the detailed configuration is not limited to this embodiment and includes design changes and the like without departing from the scope of the present invention.

Additionally, the water treatment tank 3 having the inclined part is applied to the seawater type desulfurization device in the above-described embodiment, but the present invention is not limited thereto. For example, the present invention can be also applied to the water treatment tank 3 using fresh water.

### INDUSTRIAL APPLICABILITY

The present invention relates to a water treatment tank and a desulfurization device. According to the present invention, bubbles can be retained in the treatment water for a longer time.

### REFERENCE SIGNS LIST

1 Desulfurization device
2 Desulfurization absorption tower
3 Water treatment tank
5 Seawater intake tank
6 Mixing tank
6a Mixing tank overflow wall
7 Oxidization tank
7a Oxidization tank overflow wall
8 Finishing tank
8a Finishing tank overflow wall
10 Tank body
10a Bottom surface
11 Seawater intake upstream tank
12 Seawater intake downstream tank
13 Seawater intake tank overflow wall
14 Seawater intake tank inclined part
14a Inclined surface
15 Seawater introduction line
16 Pump
17 Desulfurization seawater line
18 Pump
20 Spray nozzle
21 Exhaust gas outlet
22 Chimney
23 Drainage line
24 Bubble generator
25 Air line
26 Bubble blowing nozzle
27 Oxidization air compressor
28 Oxidization tank inclined part
30 Finishing tank inclined pan
31 Dilution seawater line
32 Discharge port
33 Perforated plate
34 Though-hole
35 Bypass flow passage
36 Bypass flow passage inlet
37 Bypass flow passage outlet
38 Bypass flow passage body
39, 39B Partition plate
41 Division plate
43 Pipe
44 Air suction portion
45 Air ejection portion
100 Plant
101 Boiler
MS Main stream
SS Sub-team
SW Seawater
SW2 Used seawater

1. A water treatment tank comprising:
a tank body that includes a bottom surface extending in a horizontal direction;
an overflow wall installed in the tank body to partition an inside space of the tank body into an upstream tank into which treatment water having absorbed sulfur from an exhaust gas is introduced and a downstream tank into which the treatment water overflowing from the upstream tank is introduced to flow therein; and
an inclined part which is installed between the bottom surface and the overflow wall in the downstream tank, wherein the inclined part is inclined downward from the overflow wall toward a downstream side of the downstream tank and of which a downstream end is connected to the bottom surface.

2. The water treatment tank according to claim 1, further comprising:
a perforated plate having a plate shape and of which a main surface is disposed along the bottom surface, wherein the perforated plate is provided with a plurality of through-holes.

3. The water treatment tank according to claim 2, further comprising:
a bubble generator that is installed under the perforated plate and that is configured to supply bubbles to the downstream tank.

4. (canceled)

5. (canceled)

6. The water treatment tank according to claim 1, further comprising:
a bypass flow passage through which the upstream tank is connected with the downstream tank wherein the treatment water supplied from the upstream tank through the bypass flow passage flows along a bottom surface of the downstream tank.

7. The water treatment tank according to claim 6, further comprising:
a partition plate that is disposed so that at least a part of which interferes with the treatment water inside the downstream tank, wherein a flow of the treatment water reversely flowing toward an upstream side of the partition plate is reduced.

8. The water treatment tank according to claim 1, further comprising:
a division plate that is disposed between an upper end of the overflow wall and a water surface of treatment water passing over the overflow wall wherein the treatment water is divided by the division plate into first falling water falling to an upstream side and a second falling water falling to a downstream side.

9. The water treatment tank according to claim 1, further comprising:
an air supply device that is configured to supply ambient air into treatment water by using a pressure of a falling water in the vicinity of a water surface or treatment water passing over the overflow wall.

10. A desulfurization device comprising:
the water treatment tank according to claim 1;
a desulfurization absorption tower which is configured to remove SO2 in an exhaust gas by absorbing SO2 into seawater; and
a drainage line which is configured to introduce used seawater discharged from the desulfurization absorption tower to the water treatment tank.
